(19) United States
(12) Patent Application Publication
(10) Pub. No.: US 2010/0302526 A1
(43) Pub. Date: Dec. 2, 2010

(54) Drive control method for moving body, exposure method, robot control method, drive control apparatus, exposure apparatus and robot apparatus

(75) Inventor: Kazuaki Saiki, Yokohama-shi (JP)

Correspondence Address: OLIFF & BERRIDGE, PLC, P.O. BOX 320850, ALEXANDRIA, VA, 22320-4850, US

(73) Assignee: NIKON CORPORATION, Tokyo (JP)

(21) Appl. No.: 12/591,214

(22) Filed: Nov. 12, 2009

Related U.S. Application Data
(60) Provisional application No. 61/193,285, filed on Nov. 13, 2008.

(51) Int. Cl. G03B 27/58; G03B 27/32; G06F 19/00; G05B 13/02

(52) U.S. Cl. 355/72; 355/77; 700/245; 318/561; 901/9

(57) ABSTRACT

A drive control apparatus includes: a first feed-forward control unit which obtains a first feed-forward signal by applying a first perfect tracking control method to a first transfer function which shows a portion of an inverse system of transfer characteristics of a control subject; a second feed-forward control unit which obtains a second feed-forward signal by applying a second perfect tracking control method to a second transfer function which shows a portion of an inverse system of transfer characteristics of the control subject and which is different from the first transfer function; and an external disturbance observer which obtains a first compensation signal for the first feed-forward signal, wherein the control subject is driven using a second compensation signal which is obtained from the second feed-forward signal and the first compensation signal.

### CROSS-REFERENCE TO RELATED APPLICATION

This application is a non-provisional application claiming priority to and the benefit of U.S. Provisional Application No. 61/193,285, filed Nov. 13, 2008. The entire contents of which are incorporated herein by reference.

### BACKGROUND

1. Field of the Invention

The present invention relates to a drive control method for a moving body, an exposure method, a robot control method, a drive control apparatus, an exposure apparatus, and a robot apparatus.

2. Description of Related Art

Conventionally, in a process to manufacture, for example, a liquid crystal display (referred to generically as flat panel displays), an exposure apparatus is widely used to form elements such as transistors and diodes on a substrate (i.e., a glass substrate). In such exposure apparatuses, a substrate on which resist has been coated is mounted on a holder of a stage apparatus, and a detailed circuit pattern which has been drawn on a mask is transferred onto the substrate via an optical system such as a projection lens or the like. In recent years, for example, it has become common for step-and-scan exposure apparatuses to be used (see, for example, Japanese Patent Application

In step-and-scan exposure apparatuses, a mask and a substrate are moved in mutual synchronization relative to a projection optical system while slit exposure light is being irradiated onto the mask. As a result, a portion of a pattern formed on the mask is sequentially transferred onto a shot area of the substrate. Each time the transferring of the pattern onto one shot area ends, the substrate is moved a step and the pattern is transferred onto another shot area.

One method of controlling the position of the stage serving as the control subject at both high speed and with a high level of accuracy which may be considered is a method in which a precise control subject model (i.e., a nominal model) is made which expresses the dynamic characteristics of the stage, and feed-forward control is performed based on this model. There are still cases in which the control accuracy is diminished such as when modeling discrepancies occur between the stage dynamic characteristics and the control subject model, or when the stage receives disturbance from external factors, however, in order to solve these problems, a control method has been developed in which an external disturbance observer is used which predicts any shift from an optimum control state as external disturbance, and this shift is then compensated in accordance with the predicted external disturbance. However, depending on the characteristics considered for the control subject model, the problem may arise that interference will be generated between the feed-forward control and the compensation of the external disturbance observer so that highly accurate control becomes impossible.

### SUMMARY

It is an object of aspects of the present invention to provide a drive control method and a drive control apparatus which, when a moving body such as a stage is controlled using an external disturbance observer and feed-forward control based on a control subject model, make it possible for highly accurate positioning control to be performed.

An aspect of the present invention is a drive control method for a moving body which uses a perfect tracking control method, wherein the method includes: a step in which a first feed-forward signal is obtained by applying a first perfect tracking control method to a first transfer function which shows a portion of an inverse system of transfer characteristics of a moving body; a step in which a second feed-forward signal is obtained by applying a second perfect tracking control method to a second transfer function which shows a portion of an inverse system of transfer characteristics of the moving body and which is different from the first transfer function; a step in which a first compensation signal for the first feed-forward signal is obtained by an external disturbance observer; a step in which a second compensation signal is obtained from the second feed-forward signal and the first compensation signal; and a step in which a drive apparatus which drives the moving body is controlled using the second compensation signal.

In the above described drive control method, it is also possible for the first transfer function to be set in accordance with at least a portion of response characteristics of the moving body that are compensated by the external disturbance observer.

In the above described drive control method, it is also possible for the first transfer function to include the mass of the moving body and a viscosity which is acting on the moving body.

In the above described drive control method, it is also possible for the first feed-forward signal and the second feed-forward signal to be signals which are obtained in accordance with shared trajectory information relating to the moving body.

In the above described drive control method, it is also possible for the second feed-forward signal to be a signal which is obtained by taking into account the effects received when the moving body is moved in a direction different from the predetermined direction.

Another aspect of the present invention is an exposure method in which a pattern is formed on a substrate which is held on a moving body, wherein the above described drive control method is used to control a drive apparatus which drives the moving body.

Another aspect of the present invention is an exposure method in which a pattern of a mask which is held on a first moving body is formed on a substrate which is held on a second moving body, wherein the above described drive control method is used to control a drive apparatus which drives at least one of the first moving body and the second moving body.

Another aspect of the present invention is a robot control method which causes a robot arm to move along a predetermined path, wherein the above described drive control method is used to control a drive apparatus which drives the robot arm as the moving body.

Another aspect of the present invention is a drive control apparatus which uses a perfect tracking control method, and which includes: a first feed-forward control unit which obtains a first feed-forward signal by applying a first perfect tracking control method to a first transfer function which shows a portion of an inverse system of transfer characteristics of a moving body; a second feed-forward control unit which obtains a second feed-forward signal by applying a second perfect tracking control method to a second transfer function which shows a portion of an inverse system of transfer characteristics of the moving body and which is different from the first transfer function; and an external disturbance observer which obtains a first compensation signal for the first feed-forward signal, wherein the moving body is driven using a second compensation signal which is obtained from the second feed-forward signal and the first compensation signal.

Another aspect of the present invention is an exposure apparatus which forms a pattern on a substrate which is held on a moving body, wherein the exposure apparatus is provided with the above described drive control apparatus as the drive control apparatus which drives the moving body.

Another aspect of the present invention is an exposure apparatus which forms a pattern of a mask on a substrate, and which is provided with; a first moving body which is able to move while holding the mask; a second moving body which is able to move while holding the substrate; and the above described drive control apparatus which drives at least one of the first moving body and the second moving body.

Another aspect of the present invention is a robot apparatus which causes a robot arm to move along a predetermined path, and which is provided with the above described drive control apparatus which drives the robot arm as the moving body.

According to some aspects of the present invention, using an external disturbance observer and feed forward control based on a control subject model, it is possible to perform highly accurate positioning control for a moving body such as a stage.

### BRIEF DESCRIPTION OF THE DRAWINGS

FIG. 1 is a schematic view showing the structure of an exposure apparatus according to an embodiment of the present invention.

FIG. 2 is a cross-sectional view showing the structure of a portion of an exposure apparatus according to the present embodiment.

FIG. 3 is a cross-sectional view showing the structure of a portion of an exposure apparatus according to the present embodiment.

FIG. 4 is a block diagram showing the structure of a control unit according to the present embodiment.

FIG. 5 is a flowchart showing an example of the manufacturing of a micro device which uses the exposure apparatus according to the present embodiment.

### DESCRIPTION OF EMBODIMENTS

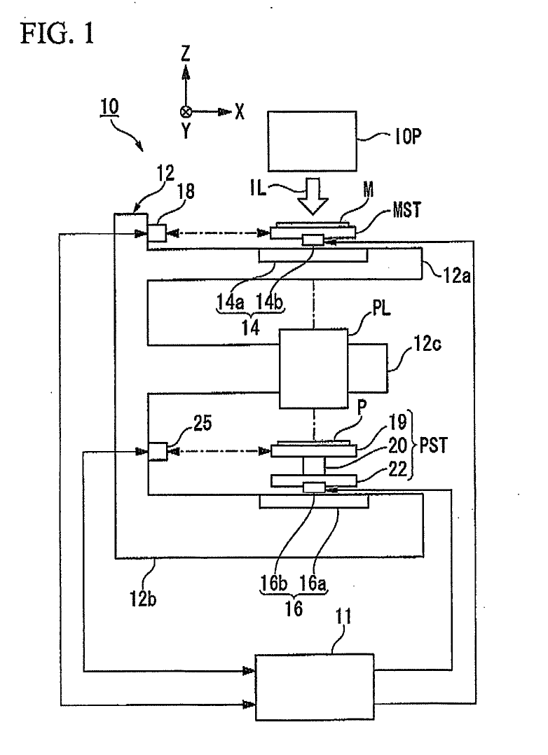

Hereinafter, an embodiment of the present invention will be described with reference made to the drawings. FIG. 1 is a schematic view showing the structure of an exposure apparatus 10 of this embodiment. This exposure apparatus 10 is an equal magnification bulk transfer type of liquid crystal scanning exposure apparatus which, by relatively scanning in a predetermined scanning direction (here, an X-axial direction in FIG. 1 (i.e., the left-right direction when looking at the surface of the paper)) at identical speeds and identical directions a mask M on which a liquid crystal display element pattern has been formed and a glass plate (hereinafter, referred to as a plate) P which serves as a substrate and which is held on a plate stage PST, transfers a pattern formed on the mask M onto the plate P.

This exposure apparatus 10 is provided with an illumination system IOP which illuminates a predetermined slit-shaped illumination area on the mask M using exposure illumination light IL (i.e., a rectangular area or arc-shaped area which extends in a narrow, elongated shape in the Y-axial direction in FIG. 1 (i.e., in a direction which is orthogonal to the surface of the paper)), a mask stage MST which moves in the X-axial direction while holding a mask M on which a pattern is formed, and a projection optical system PL which projects the exposure illumination light IL which has passed through the illumination area portion of the mask M onto the plate P, a main body column 12, a vibration isolation stand (not shown) which is used to isolate the main body column from vibration from the floor, and a control unit 11 which controls the two stages MST and PST.

As is described, for example, in Japanese Patent Application Publication No, H09-320956A, the illumination system IOP is formed by a light source unit, a shutter, a secondary light source formation optical system, a beam splitter, a condensing lens system, a field diaphragm (i.e., a blind), and a focusing lens system and the like (all of these are omitted from the drawing), and illuminates the slit-shaped illumination area on a mask M which has been mounted and held on a mask stage MST (described below) with a uniform illumination intensity.

The mask stage MST is supported by an air pad (not shown) so as to float via a clearance of approximately several μm above a top surface of a top surface plate 12a which forms part of the main body column 12, and is driven in the X-axial direction by a drive mechanism 14.

Here, a linear motor is used as the drive mechanism 14 which drives the mask stage MST, and this drive mechanism is referred to below as a linear motor 14. A stator 14a of this linear motor 14 is fixed to a top portion of the top surface plate 12a and extends in the X-axial direction. A rotor 14b of the linear motor 14 is fixed to the mask stage MST. The position of the mask stage MST in the X-axial direction is constantly measured at a predetermined resolution, for example, at a resolution of approximately several nm by a mask stage position measurement laser interferometer (hereinafter referred to as a mask interferometer) 18 which is fixed to the main body column 12 with the projection optical system PL used as a reference. Information about the position of the mask stage MST along the X-axis which is measured by this mask interferometer 18 is supplied to the control unit 11.

The projection optical system PL is placed below the top surface plate 12a of the main body column 12, and is held by a holding component 12c which forms part of the main body column 12. Here, the projection optical system PL which is used is one that projects an equal magnification erect, normal image. Accordingly, when the aforementioned slit-shaped illumination area on the mask M is illuminated by the exposure illumination light IL from the illumination system IOP, an equal magnification image of the circuit pattern in that illumination area portion (i.e., a partial erect image) is projected onto a conjugate exposure area in the illumination area on the plate P. Note that as is disclosed in, for example, Japanese Patent Application Publication No. H07-57986A, it is also possible for the projection optical system PL to be formed by a plurality of equal magnification erect projection optical system units.

Furthermore, a focal point position detection system (not shown) which measures the position in the Z-axial direction of the plate P, for example, an autofocus sensor (not shown) which is formed by a CCD or the like is fixed to the holding component 12c which holds the projection optical system PL. Information about the Z position of the plate P from this focal point position detection system is supplied to the control unit 11. In the control unit 11, for example, during a scan exposure, an autofocus operation is executed based on this Z position information to cause the Z position of the plate P to coincide with the focusing plane of the projection optical system PL.

The plate stage PST is placed under the projection optical system PL, and is supported by an air pad (not shown) so as to float via a clearance of approximately several μm above a top surface of a bottom surface plate 12b which forms part of the main body column 12. This plate stage PST is driven in the X-axial direction by a linear motor 16 serving as a drive mechanism.

A stator 16a of this linear motor 16 is fixed to the bottom surface plate 12b and extends in the X-axial direction. A rotor 16b which serves as a movable portion of the linear motor 16 is fixed to a bottom portion of the plate stage PST. The plate stage PST is provided with a moving table 22 to which is fixed the rotor 16b of the linear motor 16, a Y-drive mechanism 20 which is mounted on this moving table 22, and a plate table 19 which is provided at the top of the Y-drive mechanism 20 and which holds a plate P.

The position of the plate table 19 in the X-axial direction is constantly measured at a predetermined resolution, for example, at a resolution of approximately several nm by a plate interferometer 25 which is fixed to the main body column 12 with the projection optical system PL used as a reference. Here, a two-axis interferometer which irradiates onto the plate table 19 two X-axial direction measurement beams which are mutually separated by a predetermined distance L in the Y-axial direction which is perpendicular to the X-axial direction (i.e., in a direction which is perpendicular to the surface of the paper showing FIG. 1) is used for the plate interferometer 25, and measurement values for each measurement axis are supplied to the control unit 11.

If the measurement values for each measurement axis of this plate interferometer 25 are taken as X1 and X2, then the position of the plate table 19 in the X-axial direction can be determined (obtained) from X=(X1+X2)/2, and the amount of rotation around the Z-axis of the plate table 19 can be determined from θZ=(X1−X2)/L, however, in the description given below, except for when it is particularly necessary, this X is output from the plate interferometer 25 as X position information for the plate table 19.

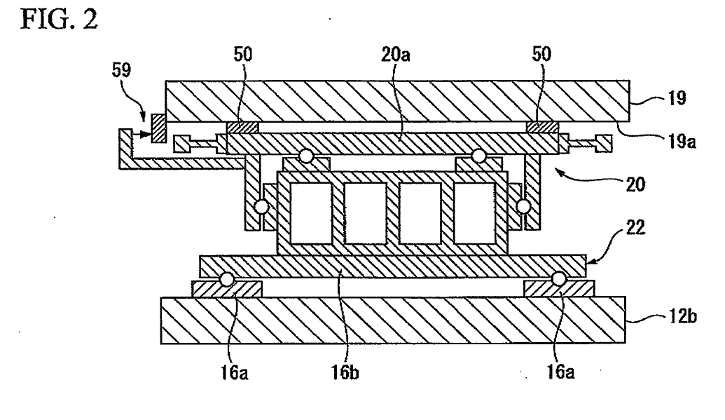

FIG. 2 is a cross-sectional view showing the detailed structure of the plate stage PST.

As is shown in FIG. 2, a leveling unit 50 is provided between a bottom surface (i.e., a surface on the −Z direction side) 19a of the plate table 19 and a Y-rotor 20a. A plurality of, for example, three leveling units 50 are provided, and these are able to control the attitude (i.e., the positions in the Z direction, the ex direction, and the θY direction) of the plate table 19 by making micro adjustments to the position in the Z direction of the plate table 19 in three locations. Namely, it is possible to adjust the positions in the Z direction, the θX direction, and the θY direction of the plate table 19 by applying predetermined force to the plate table 19 using these three leveling units 50.

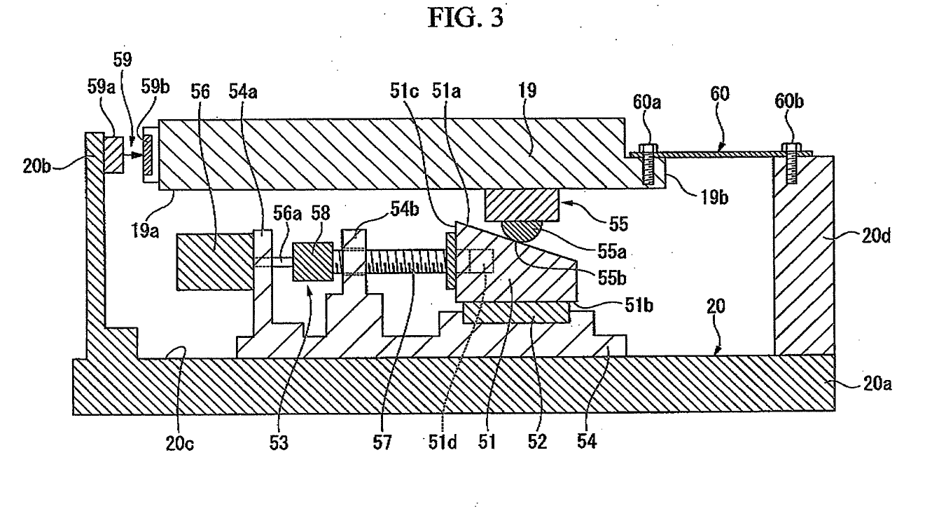

FIG. 3 shows the structure of a leveling unit 50. Because each leveling unit 50 has the same structure, the structure of one of these will be described as an example.

The leveling unit 50 is formed by a cam component 51 which is provided above the Y-rotor 20a, a guide component 52, a cam movement mechanism 53, a supporting component 54, and a bearing component 55 which is provided on the table plate 19 side.

The cam component 51 is formed having a trapezoidal cross-section, and a bottom surface 51a thereof is formed as a flat surface in a horizontal direction. This bottom surface 51a of the cam component 51 is supported on the guide component 52. A top surface 51b of the cam component 51 is a flat surface which is inclined relative to the horizontal direction. A threaded hole 31d is formed in one side surface 51c of the cam component 51. The guide component 52 is provided alongside the cam component 51 on top of the supporting component 54, and extends in the left-right direction in FIG. 3.

The cam movement mechanism 53 is formed by a servomotor 56, a ball screw 57, and a linking component 58. The servomotor 56 causes a shaft component 56a to rotate based on signals from the control unit 11. Here, this shaft component 56a extends, for example, in the left-right direction in FIG. 3. The ball screw 57 is linked via the linking component 58 to the shaft component 56a of the servomotor 56, and rotation from the shaft component 56a is transmitted to the ball screw 57. A threaded portion is provided on this ball screw 57 extending in the left-right direction in FIG. 3 (i.e., in the same direction as the axial direction of the rotation shaft of the servomotor 56), and this threaded portion screws into the threaded hole 51d formed in the side surface 51c of the cam component 51. The shaft component 56a and the ball screw 57 are supported respectively by protruding portions 54a and 54b of the supporting component 54.

In this cam drive mechanism 53, the ball screw 57 is rotated by the rotation of the servomotor 56, and the cam component 51 which is screwed together with this ball screw 57 is moved along the guide component 52 in the left-right direction in FIG. 3 by the rotation of the ball screw 57.

The beating component 55 has a portion 55a which is formed in a hemispherical shape on the bottom side thereof as seen in FIG. 3, and a bottom surface 55b of this hemispherical portion 55a is provided so as to come into contact with the top surface 51b of the cam component 51. When the cam component 51 moves, the position of contact between the bottom surface 55b of the bearing component 55 and the top surface 51b of the earn component 51 changes, and as a result of the position where it contacts the top surface 51b changing, the position in the Z direction of the bottom surface 55b also changes. The position in the Z direction of the plate table 19 can be micro-adjusted by these changes in position.

The position in the Z direction of the plate table 19 can be detected by a detection device 59. A plurality, for example, three of these detection devices 59 are also provided for the plate table 19. Each detection device 59 is formed, for example, by an optical sensor 59a and a detected component 59b. The position in the Z direction of the plate table 19 is detected as a result of the position of the detected component 59b being detected by the optical sensor 59a. Moreover, the optical sensor 59a is fixed to a protruding portion 20b which is provided on top of the Y-rotor 20a. Accordingly, the detection device 59 is able to detect the position and attitude and the like in the Z direction of the plate table 19 with the top surface 20c of the Y-rotor 20a being used as a reference. The position information detected by this detection device 59 is transmitted to the control unit 11.

Moreover, one end of the plate table 19 is connected by an elastic component 60 to a protruding portion 20d on the top of the Y-rotor 20a. One end of the elastic component 60 is fixed to an end portion 19b of the plate table 19 by means of a fixing component 60a, while the other end of the elastic component 60 is fixed to the protruding portion 20d by a fixing component 60b. Movement of the plate table 19 in the X direction and Y direction is suppressed by the elastic component 60, while movement of the plate table 19 in the Z direction is permitted.

As a result of the above described structure being employed, the plate stage PST is able to move the moving table 22 (i.e., the rotor of the linear motor 16) in the X direction (i.e., to perform X positioning), and to move the Y-rotor 20 in the Y direction relative to the moving table 22 (i.e., to perform Y positioning) such that a predetermined area for exposure of the plate P which is being held on the plate table 19 becomes positioned in the exposure area of the projection optical system PL. At this time, it is also possible to make the position of the plate P adjustable in the θZ direction. Furthermore, the plate table 19 can also be moved by the leveling unit 50 in the Z direction, the θX direction, and the θY direction relative to the Y-rotor 20a (i.e., Z positioning, and positioning in the θX and θY directions can be performed) based on detection results from the autofocus sensor and on detection results from the detection device 59 such that the Z position of the plate P matches the just-focus position (i.e., matches the focal point of the projection optical system PL).

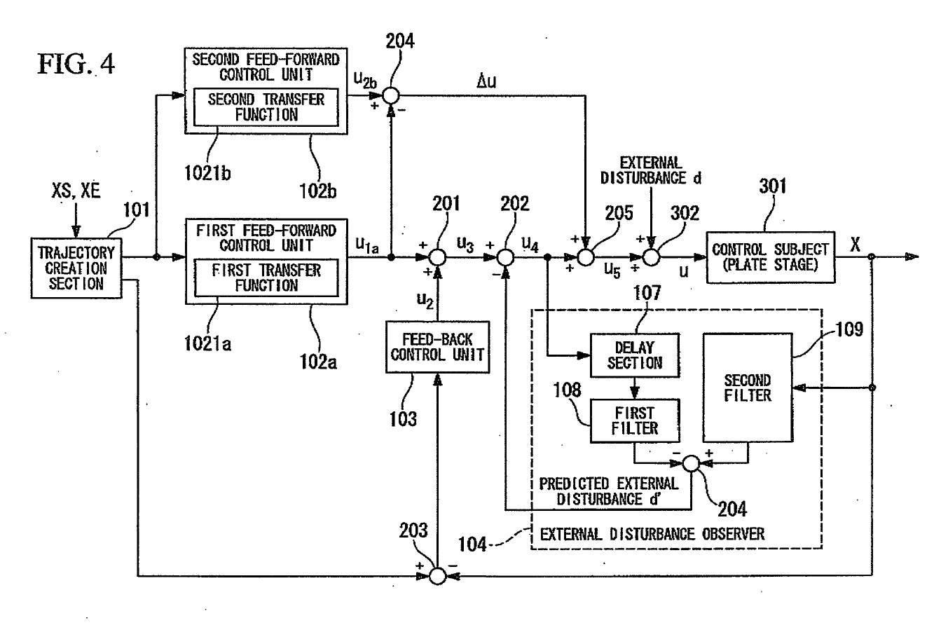

Next, a description will be given with reference made to FIG. 4 of the structure of the portion of the control unit 11 which performs drive control for the linear motor 16 which drives the plate stage PST in the X-axial direction. FIG. 4 is a block diagram showing the relevant portion of the control unit 11 and the control subject thereof. Note that the portion of the control unit 11 which performs drive control for the linear motor 14 which drives the mask stage MST in the X-axial direction has the same structure as that shown in FIG. 4. Moreover, the control unit 11 shown in FIG. 4 can also be used as the control unit for drive mechanisms which drive the plate stage PST and the mask stage MST in the Y-axial direction.

In FIG. 4, the control unit 11 is formed by a trajectory creation section 101, a first feed-forward control unit 102a, a second feed-forward control unit 102b, a feed-back control unit 103, an external disturbance observer 104, and adding sections 201 to 205. The external disturbance observer 104 is formed by a delay section 107, a first filter 108, and a second filter 109.

The trajectory creation section 101 receives inputs of an X coordinate XS of a movement start point and of an X coordinate XE of a movement end point of the plate stage PST (i.e., the control subject 301). The movement start point XS shows the current position on the X-axis of the plate stage PST, while the movement end point XE shows a target position on the X-axis which is the destination where the plate stage PST is being moved to. The trajectory creation section 101 creates a target trajectory for moving the plate stage PST from the movement start point XS to the movement end point XE based on the input movement start point XS and movement end point XE. The target trajectory is time series vector data made up of positions X (t) of the plate stage PST which are associated with respective timings “t”, and the differentials thereof up to the n−1 stage, and if necessary a suitable algorithm can be used for the creation algorithm thereof. Here, “n” is the degree of the denominator of Formula (1) described below.

The first feed-forward control unit 102a and the second-feed forward control unit 102b receive as an input a target trajectory of the next sample (namely, a target trajectory corresponding to the timing when the trajectory has moved forward one sample) which is output from the trajectory creation section 101, and perform feed-forward control based on perfect tracking control (see, for example, Japanese Patent Application Publication No. 2001-325005A and “Perfect Tracking using Multi-rate Feed-Forward Control”, H. Fujimoto et al., Transactions of the Society of Instrument and Control Engineers Vol. 36, No. 9, pp 766-772, pub. 2000) of the X coordinate positions of the plate stage PST.

Specifically, the first feed-forward control unit 102a holds (i.e., stores) a first transfer function 1021a which is a transfer function which corresponds to a portion of an inverse system (i.e., a model showing the characteristics of the control subject and also inverse responses) of the control subject 301, and uses this first transfer function 1021a to generate drive signals that are used to drive the linear motor 16. These drive signals form a manipulated variable u₁ₐ from the first feed-forward control unit 102a for the control subject 301.

The second feed-forward control unit 102b holds a second transfer function 1021b which is a transfer function which corresponds to another portion of an inverse system of the control subject 301, and uses this second transfer function 1021b to generate drive signals that are used to drive the linear motor 16. These drive signals form a manipulated variable u_{1b} from the second feed-forward control unit 102b for the control subject 301.

The first transfer function 1021a is formulated by a transfer function Fₐ (s) of the following Formula (2) which is an inverse function of a transfer function P_{R} (s) expressed by the following Formula (1) which relates to the rigid characteristics of the control subject 301. In this case, M is the mass of the plate stage PST, C is a coefficient of viscosity of the viscous force generated when the plate stage PST is driven by the linear motor 16, and the subscript “n” is a nominal value. In order to make it possible to perform precise position control which includes taking into account the viscous force generated when the plate stage PST is being driven, a mode is employed in which a viscous force item is also incorporated in the first transfer function Fₐ (s).

$$\begin{matrix}[ Formula 1 ] & \\ {P}_{R} ( s ) = \frac{1}{M \cdot {s}^{2} + C \cdot s} & ( 1 ) \\ [ Formula 2 ] & \\ {F}_{a} ( s ) = ( {M}_{n} \cdot {s}^{2} + {C}_{n} \cdot s ) & ( 2 )\end{matrix}$$

Moreover, the second transfer function 1021b is formulated by a transfer function F_{b} (s) of the following Formula (4) which is an inverse function of a product of the transfer function P_{R} (s) and a transfer function P_{H} (s) which is expressed by the following Formula (3) which relates to the delay characteristics of the control subject 301. In this case, ζ_{H} is a damping coefficient and ωₓ is a cutoff frequency.

$$\begin{matrix}[ Formula 3 ] & \\ {P}_{H} ( s ) = \frac{{ω}_{R}^{2}}{{s}^{2} + 2 \cdot {ζ}_{H} \cdot {ω}_{H} \cdot s + {ω}_{H}^{2}} & ( 3 ) \\ [ Formula 4 ] & \\ {F}_{b} ( s ) = ( {M}_{n} \cdot {s}^{2} + {C}_{n} \cdot s ) \cdot \frac{{s}^{2} + 2 \cdot {ζ}_{H} \cdot {ω}_{H} \cdot s + {ω}_{H}^{2}}{{ω}_{H}^{2}} & ( 4 )\end{matrix}$$

The manipulated variable u₁ₐ from the first feed-forward control unit 102a and the manipulated variable u_{1b} from the second feed-forward control unit 102b are input into the adding section 204, and a differential Δu=u_{1b}−u₁ₐ thereof is calculated by the adding section 204. As a result, the manipulated variable which is output from the adding section 204 and input into the adding section 205 is a manipulated variable Δu which is associated with the rigid characteristics and the delay characteristics of the control subject 301. In contrast, the manipulated variable which is input into the adding section 201 is the manipulated variable u₁ₐ which is associated with the rigid characteristics of the control subject 301.

Note that the first feed-forward control unit 102a receives inputs at a predetermined sampling cycle Tr (which is a cycle that corresponds to the degree of the first transfer function Fₐ (s), and outputs created drive signals at a predetermined sampling cycle Tu. Moreover, the second feed-forward control unit 102b receives inputs at a predetermined sampling cycle Tr′ which is different from the cycle Tr (and which is a cycle that corresponds to the degree of the second transfer function F_{b} (s), and outputs created drive signals at the same sampling cycle Tu as that of the first feed-forward control unit 102a.

Addition results from the adding section 203 are input into the feed-back control section 103. Addition results from the addition section 203 are differences between the X position of the plate stage PST (i.e., X position information obtained from the plate interferometer 25, namely, the X which is shown by the aforementioned Formula X=(X1+X2)/2) and the actual target trajectory output from the trajectory creation section 101 or else a target trajectory which takes into account the delay characteristics of the overall control device.

The feed-back control unit 103 performs feed-back control on the X coordinate position of the plate stage PST based on the output from the adding section 203, namely, on discrepancies in the X position of the plate stage PST when the target trajectory is used as a reference. Specifically, the feed-back control unit 103 generates a drive signal that is used to drive the linear motor 16 such that the aforementioned discrepancies are reduced to zero. This drive signal forms a manipulated variable u₂ from the feed-back control unit 103 for the control subject 301.

Note that the feed-back control unit 103 also receives inputs at a sampling cycle Ty in the same way as the that feed-forward control unit 102a, and outputs generated drive signals at the sampling cycle Tu.

The manipulated variable u₁ₐ from the first feed-forward control unit 102a and the manipulated variable u₂ from the feed-back control unit 103 are added together by the adding section 201 so as to create a manipulated variable u₃ (=u₁ₐ+u₂).

The external disturbance observer 104 predicts the effects of external disturbances acting on the control subject 103 or else the effects of modeled discrepancies that are equivalent to external disturbances and creates a predicted external disturbance d′. The external disturbance observer 104 then outputs the created predicted external disturbance d′ to the adding section 202. Hereinafter, the internal structure of the external disturbance observer 104 will be described.

The external disturbance observer 104 has a second filter 109 which shows a control subject model in which the dynamic characteristics of the control subject 301 have been analogously reproduced, and also shows an opposite response. The second filter 109 is formed by an inverse system which corresponds to the control subject model of the control subject 301, and by a low-pass filter which is used to remove high-frequency noise components contained in the input into the second filter 109. Of these, the inverse system is made the same as the first transfer function Fₐ (s) provided in the aforementioned first feed-forward control unit 102a in order to make it possible to accurately predict that characteristics of the control subject 301 which are not rigid characteristics are external disturbance. Moreover, the low-pass filter uses the following Formula (5). As a result, the second filter 109 has the transfer function F₂ (s) of the following Formula (6). In this case, in the following formulas, a1, b1, b2, and b3 are arbitrary constants, and ωₒ is the cutoff frequency of the filter (wherein ωₒ<ω_{H}). These transfer functions can be determined (obtained), for example, using the methods described in the following Publications 1 and 2.

Publication 1: “Robust Servo-system Design with Two Degree of Freedom and Its Application to Novel Motion Control of Robot Manipulators”, T. Umeno/T. Kanelo/Y. Hori, IEEE Transactions on Industrial Electronics, Vol. 40, No. 5, pp. 473-285, 1993

Publication 2: “Robust Motion Controller Design for High-Accuracy Positioning Systems”, H-S. Lee and M. Tomizuka, IEEE Transactions on Industrial Electronics, Vol. 43, No. 1, pp. 48-55, February 1996

$$\begin{matrix}[ Formula 5 ] & \\ L ( s ) = \frac{{a}_{1} {ω}_{c}^{2} s + {ω}_{c}^{3}}{{b}_{3} {s}^{3} + {b}_{2} {ω}_{c} {s}^{2} + {b}_{1} {ω}_{c}^{2} s + {ω}_{c}^{3}} & ( 5 ) \\ [ Formula 6 ] & \\ {F}_{2} ( s ) = ( {M}_{n} \cdot {s}^{2} + {C}_{n} \cdot s ) \cdot \frac{{a}_{1} {ω}_{c}^{2} s + {ω}_{c}^{3}}{{b}_{3} {s}^{3} + {b}_{2} {ω}_{c} {s}^{2} + {b}_{1} {ω}_{c}^{2} s + {ω}_{c}^{3}} & ( 6 )\end{matrix}$$

The X position of the plate stage PST which has been measured by the plate interferometer 25 is input into the above described second filter 109. The second filter 109 multiplies the transfer function F₂ (s) by the input X position of the plate stage PST, and outputs the result to the adding section 204. Because the transfer function F₂ (a) of the second filter 109 includes an inverse function of the transfer function P_{R} (s) of the control subject 301, the output from the second filter 109 is a value obtained by calculating the manipulated variable “u” (described below) which is input into the control subject 301.

In contrast, the manipulated variable u₄ which is the output from the adding section 202 (described below) is input into the delay section 107. This delay section 107 is provided in consideration of the fact that, when the control subject 301 is being controlled by the main control unit 11, there is a time delay from when the manipulated variable u₅ (described below) is output to the control subject 301 until the response (i.e., the X position of the plate stage PST) from the control subject 301 to this manipulated variable u₅ is obtained, and that there is also a time delay which is needed for the calculation processing in the inverse system of the second filter 109. This delay section 107 compensates for these delays so as to enable the addition to then be performed in the adding section 204. Accordingly, the delay section 107 first delays the input manipulated variable u₄ by a time ΔT, which is equal to the sum of these time delays, and then outputs it to the first filter 108. Note that the value of the total amount ΔT of the time delays may also be determined (obtained) by preliminary measurements.

The first filter 108 has the same transfer function F₁ (s) as that of a low-pass filter L(a) of the above described second filter 109. This transfer function F₁ (s) is multiplied by the output from the delay section 107 and the result of this is output to the adding section 204.

Note that the first filter 108 is used with the aim of equalizing reference levels of the two values added in the adding section 204 due to the fact that it multiplies the same filter function as the low-pass filter of the second filter 109.

The adding section 204 calculates a difference between the output from the second filter 109 and the output from the first filter 108. This difference is taken as a predicted external disturbance d′ and forms the output from the external disturbance observer 104.

The adding section 202 subtracts the predicted external disturbance d′ output from the external disturbance observer 104 from the aforementioned manipulated variable u₃, and outputs a manipulated variable u₄ obtained after this subtraction (=u₃−d′) to the adding section 205.

The adding section 205 adds the aforementioned manipulated variable Δu to the manipulated variable u₄ from the adding section 202, and outputs a manipulated variable u₅ which is the result of this addition (=u₄+Δu). This manipulated variable u₅ is the manipulated variable supplied from the control unit 11 to the control subject 301.

In addition to the manipulated variable u₅ from the control unit 11, the control subject 301 also receives the input of the manipulated variable “u” to which the external disturbance “d” has been added in the adding section 302. From the above, the manipulated variable “u” which is input into the control subject 301 is expressed by the following formula.

$$\begin{matrix}u = {u}_{5} + d \\ = {u}_{4} + Δ u + d \\ = {u}_{3} - {d}^{′} + Δ u + d \\ = {u}_{1 a} + {u}_{2} - {d}^{′} + {u}_{1 b} - {u}_{1 a} + d \\ = {u}_{1 b} + {u}_{2} - {d}^{′} + d\end{matrix}$$

The above external disturbance d which is included in the manipulated variable “u” is generated due to modeling discrepancies in the first transfer function Fₐ (a) in the first feed-forward control unit 102a, and due to modeling discrepancies in, the second transfer function F_{b} (s) in the second feed-forward control unit 102b. Namely, when nominal values Mₙ for the mass and nominal values Cₙ for the coefficient of viscosity contained in the respective transfer functions Fₐ (s) and F_{b} (s) deviate from the actual rigid characteristics (i.e., the values for the actual mass M and coefficient of viscosity C) of the control subject 301, then external disturbance is generated. This external disturbance is taken as d₁. Moreover, even if the P_{H} (s) of Formula (3) contained in the transfer function F_{b} (s) does not take into consideration the actual delay characteristics of the control subject 301, external disturbance is still generated. This external disturbance is taken as d₂. In this way, the external disturbance d can be expressed as d=d₁+d₂.

Here, as is understood from the above described Formula (6), because the external disturbance observer 104 predicts external disturbance using the second filter 109 which is based on rigid characteristics of the control subject 301, the external disturbance d₁ is obtained as the result of this prediction. Namely, the predicted external disturbance d′ is equivalent to the external disturbance d₁.

Accordingly, by using the external disturbance observer 104, the above described manipulated variable “u” can be expressed as

u=+u_{1b}+u₂+d₂,

and, using this manipulated variable “u”, the output from the control subject 301, namely, the X position of the plate stage PST can be expressed as is shown in the following Formula (7). In this case, X (s) is the Laplace transform of the X position of the plate stage PST, and Pₙ (s) is the transfer function of the control subject 301 which has been nominalized by the external disturbance observer 104. Note that in Formula (7), the manipulated variable u₂ item relating to the feed-back control has been omitted.

$$\begin{matrix}[ Formula 7 ] & \\ \begin{matrix}X ( s ) = {P}_{n} ( s ) \cdot u \\ = \frac{1}{{M}_{n} \cdot {s}^{2} + {C}_{n} \cdot s} \cdot u \\ = \frac{1}{{M}_{n} \cdot {s}^{2} + {C}_{n} \cdot s} \cdot {u}_{1 b} + \frac{1}{{M}_{n} \cdot {s}^{2} + {C}_{n} \cdot s} \cdot {d}_{2}\end{matrix} & ( 7 )\end{matrix}$$

In contrast, in order to determine (obtain) a formula for the external disturbance d₂, if it is assumed that a manipulated variable u₀ which is based solely on the rigid characteristics of the control subject 301 is input into the control subject 301, then the output from the control subject 301 is as shown in the following Formula (8). In this case, P(s) is the transfer function of the non-nominalized control subject 301.

$$\begin{matrix}[ Formula 8 ] & \\ \begin{matrix}X ( s ) = P ( s ) \cdot {u}_{0} \\ = {P}_{R} ( s ) \cdot {P}_{H} ( s ) \cdot {u}_{0} \\ = \frac{1}{M \cdot {s}^{2} + C \cdot s} \cdot \frac{{ω}_{H}^{2}}{{s}^{2} + 2 \cdot {ζ}_{H} \cdot {ω}_{H} \cdot s + {ω}_{H}^{2}} \cdot {u}_{0} \\ = \frac{1}{M \cdot {s}^{2} + C \cdot s} \cdot {u}_{0} + \frac{1}{M \cdot {s}^{2} + C \cdot s} \cdot \frac{\begin{matrix}- {s}^{2} - 2 \cdot {ζ}_{H} \cdot \\ {ω}_{H} \cdot s\end{matrix}}{\begin{matrix}{s}^{2} + 2 \cdot {ζ}_{H} \cdot \\ {ω}_{H} \cdot s + {ω}_{H}^{2}\end{matrix}} \cdot {u}_{0} .\end{matrix} & ( 8 )\end{matrix}$$

In Formula (8), the first item on the right side is the ideal response component if the control subject 301 only has rigid characteristics, while the second item is the response component corresponding to the external disturbance d₂ which is caused by characteristics other than the rigid characteristics of the control subject 301, namely, by the delay characteristics expressed by the transfer function P_{H} (s). Accordingly, from Formula (7) and Formula (8) it can be understood that the external disturbance d₂ is expressed by the following Formula (9).

$$\begin{matrix}[ Formula 9 ] & \\ {d}_{2} = \frac{- {s}^{2} - 2 \cdot {ζ}_{H} \cdot {ω}_{H} \cdot s}{{s}^{2} + 2 \cdot {ζ}_{H} \cdot {ω}_{H} \cdot s + {ω}_{H}^{2}} \cdot {u}_{1 b} & ( 9 )\end{matrix}$$

If Formula (9) is used, then Formula (7) can be expressed as is shown in the following Formula (10).

$$\begin{matrix}[ Formula ( 10 ) ] & \\ X ( s ) = \frac{1}{{M}_{n} \cdot {s}^{2} + {C}_{n} \cdot s} \cdot {u}_{1 b} + \frac{1}{\begin{matrix}{M}_{n} \cdot {s}^{2} + \\ {C}_{n} \cdot s\end{matrix}} \cdot \frac{\begin{matrix}- {s}^{2} - 2 \cdot {ζ}_{H} \cdot \\ {ω}_{H} \cdot s\end{matrix}}{\begin{matrix}{s}^{2} + 2 \cdot {ζ}_{H} \cdot \\ {ω}_{H} \cdot s + {ω}_{H}^{2}\end{matrix}} \cdot {u}_{1 b} & ( 10 )\end{matrix}$$

Here, the manipulated variable u_{1b} from the second feed-forward control unit 102b is expressed by the following Formula (11) using the Laplace transform r (s) of the target trajectory X (t) and Formula (4) of the second transfer function F_{b} (s).

$$\begin{matrix}[ Formula 11 ] & \\ \begin{matrix}{u}_{1 b} = {F}_{b} ( s ) \cdot r ( s ) \\ = ( {M}_{n} \cdot {s}^{2} + {C}_{n} \cdot s ) \cdot \frac{{s}^{2} + 2 \cdot {ζ}_{H} \cdot {ω}_{H} \cdot s + {ω}_{H}^{2}}{{ω}_{H}^{2}} \cdot r ( s )\end{matrix} & ( 11 )\end{matrix}$$

Accordingly, from Formula (10) and Formula (11), the output from the control subject 301 is

X(s)=r (s).

This indicates that the X position of the plate stage PST matches the target trajectory.

In this manner, in addition to the first feed-forward control unit 102a which has the first transfer function Fa (s), by also using the external disturbance observer 104 in combination with the second feed-forward control unit 102b which has the second transfer function Fb (s), it is possible to perform control to match the X position of the plate stage PST to the target trajectory.

An embodiment of this invention has been described above in detail with reference made to the drawings, however, the specific structure thereof is not limited to this embodiment and various design modifications and the like may be made insofar as they do not depart from the spirit or scope of the present invention.

For example, in the control unit 11 described in FIG. 4, by using a transfer function Pₖ (s) (wherein k=1, 2, . . . is the degree of vibration) which is expressed by the following Formula (12) which relates to the vibration mode characteristics of the control subject 301 instead of using the transfer function P_{H} (s) which relates to the delay characteristics of the control subject 301, it is possible to perform control in which consideration is given to the vibration mode characteristics of the control subject 301. Specifically, the P_{H} (s) in the second transfer function 1021b of the second feed-forward control unit 102b can be replaced by Pₖ (s). Moreover, it is also possible for the denominator of the second transfer function 1021b to be made the sum of P_{R} (s) and P_{H}(s) and Pₖ (s).

$$\begin{matrix}[ Formula 12 ] & \\ {P}_{k} ( s ) = \frac{{s}^{2} + 2 \cdot {ζ}_{kk} \cdot {ω}_{kk} \cdot s + {ω}_{kk}^{2}}{{s}^{2} + 2 \cdot {ζ}_{k} \cdot {ω}_{k} \cdot s + {ω}_{k}^{2}} & ( 12 )\end{matrix}$$

Moreover, for example in the structure shown in FIG. 4, instead of the second feed-forward control unit 102b and the adding section 204, it is also possible for the control unit 11 to be provided with another feed-forward control unit which has the difference F_{b} (a)-Fₐ (s) of the respective transfer functions of the above described Formula (2) and (4) as a transfer function. In this case as well, because the control object 301 is supplied with a manipulated variable which is equal to the above described manipulated variable u, it is possible to obtain the equivalent control performance as from the structure shown in FIG. 4.

Moreover, in the control system shown in FIG. 4 which drives the plate stage PST in the X-axial direction, there are cases when the drive control of the plate stage PST in other axial directions (i.e., the Y direction or Z direction) generates an effect in the form of the external disturbance “d” shown in FIG. 4. In such cases, by employing a structure in which there is provided an external disturbance trajectory creation section (i.e., an external disturbance model) which creates a trajectory that compensates for this external disturbance based on command values (i.e., manipulated variables) used for controlling the other axes, and in which the created external disturbance trajectory is added to the aforementioned target trajectory and is then input into the second feed-forward control unit 102b, it becomes possible to eliminate the effects generated from the control of the other axes.

Moreover, the above described example is based on a method (known as digital redesigning) in which an external disturbance observer designed in a continuous time series undergoes bilinear transform so that a discrete time external disturbance observer is obtained, it is also possible to use a method in which a minimal order observer is designed using Gopinath's method based on a discrete time equation of state obtained by performing a zero-order hold transform on a nominal model, so as to directly obtain a discrete time external disturbance observer. In the latter method, because it perfectly matches the discrete time nominal model used in perfect tracking control, a tracking system having a greater degree of accuracy can be achieved.

Note that in each of the above described embodiments, an example is described in which a semiconductor wafer which is used to manufacture a semiconductor device is exposed, however, in addition to this, the same description can also apply when a glass substrate which is used for a display device, a ceramic wafer which is used for a thin-film magnetic head, or an original plate (i.e., synthetic quartz or silicon wafer) of a mask or reticle which is used in an exposure apparatus, or the like is being exposed.

As the exposure apparatus EX, in addition to a step-and-scan type of scanning exposure apparatus (i.e., a scanning stepper) which makes a scanning exposure of a pattern on a reticle R while moving the reticle R and a wafer W in synchronization, it is also possible to use a step-and-repeat type of projection scanning device (i.e., a stepper) that collectively exposes the pattern on the reticle R while the reticle R and wafer W are stationary, and moves the wafer W in sequential steps. Moreover, the present invention can also be applied to a step-and-stitch type of exposure apparatus in which at least two patterns are partially superimposed and transferred onto a wafer W.

The type of exposure apparatus EX that is used is not limited to an exposure apparatus for manufacturing a semiconductor device that exposes a semiconductor device pattern onto a wafer W, and the present invention may also be broadly applied to exposure apparatuses for manufacturing liquid crystal display elements or for manufacturing displays and the like, and to exposure apparatuses for manufacturing thin-film magnetic heads, image pickup elements (CCD), or reticles and masks, and the like.

As the light source for an exposure apparatus in which the present invention is used, not only is it possible to use a KR excimer laser (having a wavelength of 248 nm), an ArF excimer laser (having a wavelength of 193 nm), and an F2 laser (having a wavelength of 157 nm) and the like, but it is also possible to use g-rays (having a wavelength of 436 nm) or i-rays (having a wavelength of 365 nm). Furthermore, the magnification of the projection optical system is not limited to being a reducing system, but may also be either an equal magnification system, or an enlarging system. Moreover, in the above described embodiments, a reflective-refractive type of projection optical system is used as an example, however, the present invention is not limited to this and can also be applied to a refractive type of projection optical system in which the optical axis of the projection optical system (i.e., the center of the reticle) and the center of the projection area are set in different positions.

Moreover, the present invention can also be applied to what is known as an immersion exposure apparatus in which a space between the projection optical system and the substrate is filled in localized portions with a liquid, and the substrate is then exposed via this liquid. This immersion exposure method is disclosed in, for example, International Patent Publication No. WO 99/49504. Furthermore, the present invention can also be applied to an immersion exposure apparatus in which exposure is performed with the entire surface of the substrate which is to be exposed being immersed in the liquid, such as is disclosed in, for example, Japanese Patent Application Publication Nos. H06-124873A and H10-303114A, and in U.S. Pat. No. 5,825,043.

The present invention can also be applied to a twin stage type of exposure apparatus that is provided with a plurality of substrate stages (i.e., wafer stages). The structure and exposure operations of a twin stage type of exposure apparatus are disclosed in, for example, Japanese Patent Application Publication Nos. H10-163099A and H10-214783A (corresponding to U.S. Pat. Nos. 6,341,007; 6,400,441; 6,549,269; and 6,590,634), Published Japanese translation No. 2000-505958 of PCT International Publication (corresponding to U.S. Pat. No. 5,969,441), U.S. Pat. No. 6,208,407, and the like. Furthermore, the present invention may also be applied to the wafer stage of Japanese Patent Application No. 2004-168481 for which application has already been made by the applicants of the present specification.

Moreover, an exposure apparatus in which the present invention is applied is manufactured by assembling various subsystems which include the respective component elements such that they have a predetermined mechanical accuracy, electrical accuracy and optical accuracy. In order to secure these levels of accuracy, both before and after the assembly steps, adjustments to achieve optical accuracy in the various optical systems, adjustments to achieve mechanical accuracy in the various mechanical systems, and adjustments to achieve electrical accuracy in the various electrical systems are made. The assembly step to assemble an exposure apparatus from the various subsystems includes making mechanical connections, electrical circuit wiring connections, and air pressure circuit tube connections and the like between the various subsystems. Prior to the assembly step to assemble an exposure apparatus from the various subsystems, it is of course necessary to perform assembly steps to assemble the respective individual subsystems. Once the assembly step to assemble an exposure apparatus from the various subsystems has ended, comprehensive adjustments are made so as to secure various levels of accuracy in the exposure apparatus as a whole. Note that it is desirable for the manufacturing of the exposure apparatus to be conducted in a clean room in which temperature and cleanliness and the like are controlled.

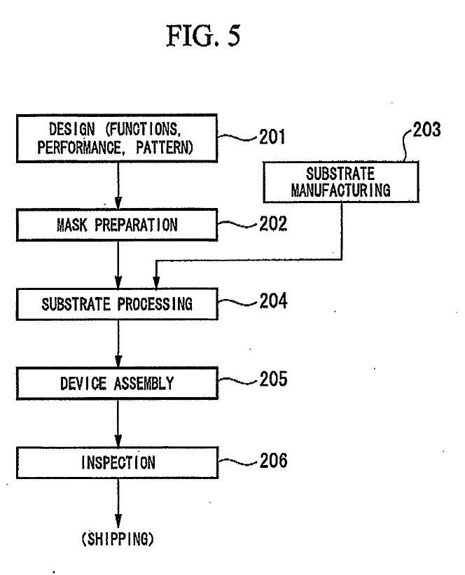

Next, an embodiment of a method of manufacturing a micro device in which the exposure apparatus and exposure method according to the embodiment of the present invention are used in a lithographic step will be described. FIG. 5 shows a flowchart of an example of the manufacturing of a micro device (i.e., a semiconductor chip such as an IC or LSI, a liquid crystal panel, a CCD, a thin film magnetic head, a micro machine, and the like).

Firstly, in step 201 (a design step), the designing of the functions and performance of the micro device (for example, the designing of the circuit of a semiconductor device and the like) is performed, and a pattern is designed in order to achieve these functions. Next, in step 202 (a mask manufacturing step), a mask (reticle) on which the designed circuit pattern has been formed is manufactured. Meanwhile, in step 203 (a wafer manufacturing step), a wafer is manufactured using a material such as silicon or the like.

Next, in step 204 (a wafer processing step), using the mask and wafer prepared in steps 201 to 203, as is described below, an actual circuit or the like is formed on the wafer using lithographic technology. Next, in step 205 (a device assembly step), a device is assembled using the wafer that was processed in step 204. In this step 205, steps such as a dicing step, a bonding step, a packaging step (i.e., enclosure in a chip), and the like are included according to requirements. Finally, in step 206 (an inspection step), inspections such as an operation verification test, a durability test, and the like are performed on the micro device manufactured in step 205. After passing through these steps, the micro device is completed, and the completed device is then shipped.

The present invention can be applied not only to micro devices such as semiconductors, but also to exposure apparatuses which transfer a circuit pattern from a mother reticle onto a glass substrate or silicon wafer or the like in order to manufacture a reticle or mask which is used in a light exposure apparatus, an EUV exposure apparatus, an X-ray exposure apparatus, or an electron beam exposure apparatus or the like. Here, in an exposure apparatus which uses deep ultraviolet (DUV) light or vacuum ultraviolet (VUV) light ox the like, generally, a transmission type of reticle is used, and quartz glass, fluorine-doped quartz glass, fluorite, magnesium fluoride, or crystal or the like can be used for the reticle substrate. Moreover, in proximity type X-ray exposure apparatuses and electron beam exposure apparatuses and the like, a transmission type of mask (i.e., a stencil mask or membrane mask) is used, and a silicon wafer or the like can be used for the mask substrate. Note that this type of exposure apparatus is disclosed in WO 99/34255, WO 99/50712, WO 99/66370, Japanese Patent Application Publication Nos. H11-194479A, 2000-12453A, and 2000-29202A.

By incorporating software and programs, it is possible to apply the drive control method of the present invention without having to substantially alter the exposure apparatus. As a result of this, it is possible for the stabilization time of the exposure apparatus to be shortened. This is beneficial for improving the processing performance of an exposure apparatus and for improving throughput.

Moreover, generally, if an exposure apparatus has been substantially altered in order to improve the acceleration thereof, there is a possibility that the stabilization time will increase. By applying the present invention, it is possible to limit these increases in the stabilization time which are brought about by such alterations. This is beneficial for improving the processing performance of an exposure apparatus and for improving throughput.

Moreover, the present invention is not limited to exposure apparatuses and can also be applied to robot apparatuses. In a robot apparatus it is necessary to set a path along which the robot arm approaches a work piece and a path along which the robot arm moves away from the work piece so that the movements of the robot arm can be accurately set. However, if any external disturbance acts on the robot apparatus, then it becomes no longer possible to obtain a sufficient positioning accuracy, and there is a possibility that the robot arm will not be able to follow the desired path. Therefore, in the structure shown in FIG. 4, by taking the control subject 301 as a robot arm, and by creating a path (i.e., a trajectory) for the robot atm using the trajectory creation section 101, and by also setting the first transfer function Fₐ (a), the second transfer function F_{b}(s), and the second filter transfer function F₂ (s) as formulas which correspond to appropriate robot arm control characteristics, it is possible to achieve a robot apparatus in which highly accurate control is possible in the same way as in the above described embodiment of the exposure apparatus.

By incorporating software and programs, it is possible to apply the drive control method of the present invention without having to substantially alter the robot apparatus. As a result of this, it is possible for the stabilization time of the robot apparatus to be shortened. This is beneficial for improving the performance of a robot apparatus.

Moreover, by applying the present invention in order to achieve an improvement in the acceleration of a robot apparatus, it is possible to limit any increases in the stabilization time. This is also beneficial for improving the performance of a robot apparatus.

The drive control method of the present invention may be supplied, for example, as a predetermined computer program, and can be stored on media, a device, or in memory or the like.

It is possible for the various apparatuses such as an exposure apparatus or robot apparatus to be provided with an internal computer system. The above described processing steps can be stored on a computer-readable recording medium in program format, and this program can be executed upon being read by the computer thereby enabling the above described processing to be executed. Here, ‘computer-readable recording medium’ refers to a magnetic disc, a magneto-optical disc, a CD-ROM, a DVD-ROM, or semiconductor memory or the like. Furthermore, it is also possible for this computer program to be delivered to a computer via a communication circuit and for the computer which receives this delivery to execute the program.

Moreover, the program may be one that performs a portion of the above functions. Furthermore, the program may also be one that performs the above functions in combination with a program that is already recorded on a computer system, or else may be what is known as a differential file (i.e., a differential program).

1. A drive control method for a moving body which uses a perfect tracking control method, comprising:
obtaining a first feed-forward signal by applying a first perfect tracking control method to a first transfer function which shows a portion of an inverse system of transfer characteristics of a moving body;
obtaining a second feed-forward signal by applying a second perfect tracking control method to a second transfer function which shows a portion of an inverse system of transfer characteristics of the moving body and which is different from the first transfer function;
obtaining a first compensation signal for the first feed-forward signal by an external disturbance observer;
obtaining a second compensation signal from the second feed-forward signal and the first compensation signal; and
controlling a drive apparatus which drives the moving body using the second compensation signal.

2. The drive control method according to claim 1, wherein the first transfer function is set in accordance with at least a portion of response characteristics of the moving body that are compensated by the external disturbance observer.

3. The drive control method according to claim 1, wherein the first transfer function includes the mass of the moving body and a viscosity which is acting on the moving body.

4. The drive control method according to claim 1, wherein the first feed-forward signal and the second feed-forward signal are signals which are obtained in accordance with shared trajectory information relating to the moving body.

5. The drive control method according to claim 1, wherein the second feed-forward signal is a signal which is obtained by taking into account the effects received when the moving body is moved in a direction different from the predetermined direction.

6. An exposure method in which a pattern is formed on a substrate which is held on a moving body, wherein
the drive control method according to claim 1 is used to control a drive apparatus which drives the moving body.

7. An exposure method in which a pattern of a mask which is held on a first moving body is formed on a substrate which is held on a second moving body, wherein
the drive control method according to claim 1 is used to control a drive apparatus which drives at least one of the first moving body and the second moving body.

8. A robot control method which causes a robot arm to move along a predetermined path, wherein
the drive control method according to claim 1 is used to control a drive apparatus which drives the robot arm as the moving body.

9. A drive control apparatus which uses a perfect tracking control method, comprising:
a first feed-forward control unit which obtains a first feed-forward signal by applying a first perfect tracking control method to a first transfer function which shows a portion of an inverse system of transfer characteristics of a moving body;
a second feed-forward control unit which obtains a second feed-forward signal by applying a second perfect tracking control method to a second transfer function which shows a portion of an inverse system of transfer characteristics of the moving body and which is different from the first transfer function; and
an external disturbance observer which obtains a first compensation signal for the first feed-forward signal, wherein
the moving body is driven using a second compensation signal which is obtained from the second feed-forward signal and the first compensation signal.

10. An exposure apparatus which forms a pattern on a substrate which is held on a moving body, comprising
a drive control apparatus according to claim 9 as the drive control apparatus which drives the moving body.

11. An exposure apparatus which forms a pattern of a mask on a substrate, comprising:
a first moving body which is able to move while holding the mask;
a second moving body which is able to move while holding the substrate; and
a drive control apparatus according to claim 9 which drives at least one of the first moving body and the second moving body.

12. A robot apparatus which causes a robot arm to move along a predetermined path, comprising
the drive control apparatus according to claim 9 which drives the robot arm as the moving body.
